(19) United States
(12) Patent Application Publication
(10) Pub. No.: US 2025/0155964 A1
(43) Pub. Date: May 15, 2025

(54) SPECIAL EFFECT DISPLAY METHOD AND APPARATUS, ELECTRONIC DEVICE, AND STORAGE MEDIUM

(71) Applicant: Beijing Zitiao Network Technology Co., Ltd., Beijing (CN)

(72) Inventors: Yuwei ZHOU, Beijing (CN); Wenhui ZHAO, Beijing (CN); Mengqi TU, Beijing (CN); Yang YANG, Beijing (CN); Qi HUANG, Beijing (CN); Weicheng ZHANG, Beijing (CN)

(21) Appl. No.: 18/726,352

(22) PCT Filed: Apr. 27, 2023
(86) PCT No.: PCT/CN2023/091161

§ 371 Date: Jul. 2, 2024

(30) Foreign Application Priority Data
May 17, 2022 (CN) 202210542347.3

(51) Int. Cl. G06F 3/01

(52) U.S. Cl. CPC G06F 3/011

(57) ABSTRACT

The present disclosure relates to the technical field of computers, and in particular to an special effect display method and apparatus, an electronic device, and a storage medium. The special effect display method provided in embodiments of the present disclosure comprises: displaying a virtual reality space; presenting media content in the virtual reality space; and presenting, on the basis of the media content, an special effect associated with the media content in the virtual reality space.

### CROSS-REFERENCE TO RELATED APPLICATIONS

This application is a U.S. National Stage under 35 U.S.C. § 371 of International Application No. PCT/CN2023/091161, as filed on Apr. 27, 2023, which is based on and claims priority to CN patent application Ser. No. 20/221,0542347.3 titled “SPECIAL EFFECT DISPLAY METHOD AND APPARATUS, ELECTRONIC DEVICE, AND STORAGE MEDIUM” and filed on May 17, 2022, the disclosure of each of these applications is incorporated by reference herein in its entirety.

### TECHNICAL FIELD

The present disclosure relates to the technical field of computers, in particular to an effect display method and apparatus, an electronic device and a storage medium.

### BACKGROUND

With the development of virtual reality (VR) technologies, more and more virtual social platforms or applications have been developed for use by the user. In a virtual social platform, the user may control own avatar to carry out social interaction, entertainment, learning, remote office, and user generated content (UGC) creation with avatars controlled by other users through smart terminal devices such as head-mounted VR glasses. However, the interactive forms provided by related virtual social platforms are relatively simple, so that it is impossible to satisfy diversified interactive needs of users.

### SUMMARY

The summary is provided to introduce concepts in a concise form, which will be described in detail in the following detailed description. The summary is neither intended to identify the key features or essential features of the technical solution for which protection is sought, nor intended to limit the scope of the technical solution for which protection is sought.

In a first aspect, according to one or more embodiments of the present disclosure, an effect display method is provided, the method comprising:
displaying a virtual reality space;
presenting media content in the virtual reality space; and
presenting an effect associated with the media content in the virtual reality space on the basis of the media content.

In a second aspect, according to one or more embodiments of the present disclosure, an effect display apparatus is provided, the apparatus comprising:
a space display unit for displaying a virtual reality space;
a media content presenting unit for presenting media content in the virtual reality space; and
an effect presenting unit for presenting an effect associated with the media content in the virtual reality space on the basis of the media content.

In a third aspect, according to one or more embodiments of the present disclosure, an electronic device is provided, the electronic device comprising: at least one memory and at least one processor; wherein the memory is used for storing program codes, and the processor is used for calling the program codes stored in the memory to cause the electronic device to perform the effect display method provided according to one or more embodiments of the present disclosure.

In a fourth aspect, according to one or more embodiments of the present disclosure, a non-transient computer storage medium is provided, the non-transient computer storage medium having program codes stored thereon that, when executed by a computer device, cause the computer device to perform the effect display method provided according to one or more embodiments of the present disclosure.

According to one or more embodiments of the present disclosure, the effect associated with the media content is presented in the virtual reality space on the basis of the media content, so that the corresponding effect can be presented while the media content is displayed in the virtual reality space, thereby enabling users to obtain richer interactive experience in the virtual reality space.

### BRIEF DESCRIPTION OF THE ACCOMPANYING DRAWINGS

The above-described and other features, advantages and aspects of embodiments of the present disclosure will become more apparent in conjunction with the accompanying drawings and with reference to the following detailed description. Throughout the accompanying drawings, the same or similar reference numerals indicate the same or similar elements. It should be understood that the accompanying drawings are schematic, and the members and elements are not necessarily drawn to scale.

FIG. 1 is a schematic structural view of a virtual reality device provided according to an embodiment of the present disclosure;

FIG. 2 is a flowchart of an effect display method provided according to an embodiment of the present disclosure;

FIG. 3 is a schematic view of a virtual reality space provided according to an embodiment of the present disclosure;

FIG. 4 is a schematic structural view of an effect display apparatus provided according to an embodiment of the present disclosure;

FIG. 5 is a schematic structural view of an electronic device provided according to an embodiment of the present disclosure.

### DETAILED DESCRIPTION

The embodiments of the present disclosure will be described in more detail with reference to the accompanying drawings below. Although the accompanying drawings illustrate some embodiments of the present disclosure, it should be understood that the present disclosure may be implemented in various forms, and should not be construed as being limited to the embodiments set forth herein; rather, these embodiments are provided for a more thorough and complete understanding of the present disclosure. It should be understood that the accompanying drawings and embodiments of the present disclosure are only for illustrative purposes, rather than for limiting the protection scope of the present disclosure.

It should be understood that the steps recited in the embodiments of the present disclosure may be performed according to different sequences, and/or performed in parallel. In addition, the embodiments may comprise additional steps and/or omit to perform the illustrated steps. The scope of the present disclosure is not limited in this respect.

As used herein, the term “comprising” and its variants are open-ended inclusion, that is, “comprising but not limited to”. The term “on the basis of” means “at least partially on the basis of”. The term “one embodiment” means “at least one embodiment”;

the term “another embodiment” means “at least one additional embodiment”; the term “some embodiments” means “at least some embodiments”. The term “in response to” and related terms mean that one signal or event is affected by another signal or event to some extent, but not necessarily affected completely or directly. If the event x occurs “in response to” to the event y, x may be in response to y directly or indirectly. For example, the occurrence of y might eventually lead to the occurrence of x, but there might be other intermediate events and/or conditions. In other circumstances, y might not necessarily lead to the occurrence of x, and x might also occur even if y has not yet occurred. Furthermore, the term “in response to” may also mean “at least partially in response to”.

The term “determining” covers a wide range of various actions, which may comprise obtaining, calculus, calculation, processing, derivation, investigation, searching (for example, searching in a table, a database or other data structures), proving, and similar actions, and may also comprise receiving (for example, receiving information), accessing (for example, accessing data in a memory) and similar actions, as well as parsing, choosing, selection, establishing and similar actions. The related definitions of other terms will be given in the following description.

It is to be noted that the concepts such as “first” and “second” mentioned in the present disclosure are only used to distinguish different devices, modules or units, but not to limit the order or interdependence of functions performed by these devices, modules or units.

It is to be noted that the qualifiers “one” and “a plurality of” mentioned in the present disclosure are llustrative rather than restrictive, and those skilled in the art should understand that they should be understood as “one or more” unless specified in the context otherwise.

For the purpose of the present disclosure, the phrase “A and/or B” means (A), (B) or (A and B).

The names of messages or information exchanged between multiple devices in the embodiments of the present disclosure are only used for illustrative purposes, but not for limiting the scope of these messages or information.

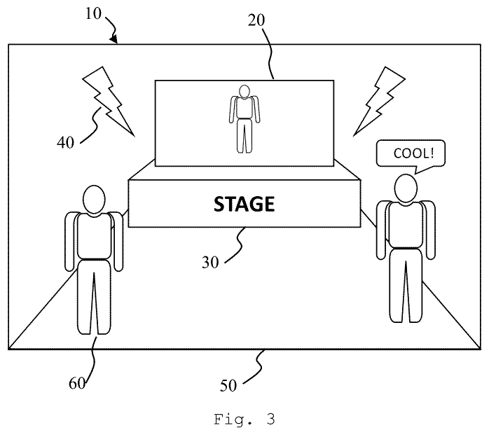

Referring to FIG. 2, FIG. 2 shows a flowchart of an effect display method 100 provided by an embodiment of the present disclosure, and the method 100 comprises steps S120 to S160.

In step S120, a virtual reality space is displayed.

In some embodiments, the virtual reality space may be realized by an extended reality (XR) device. The extended reality technology may combine reality and virtuality through a computer, and provide the user with a virtual reality space where human-computer interaction is available, so that the virtual reality space may be displayed in three-dimensional images. In the virtual reality space, the user may control own avatar to carry out social interaction, entertainment, learning, working, remote office, and user generated content (UGC) creation with avatars controlled by other users through smart terminal devices such as head-mounted VR glasses and a head mount display (HMD).

In this embodiment, the extended reality technology comprises but is not limited to augmented reality (AR), virtual reality (VR), mixed reality (MR), Augmented Virtuality (AV) and other technologies.

The extended reality devices recited in the embodiments of the present disclosure may comprise, but are not limited to, the following types:

The PC-end virtual reality (PCVR) device, using the PC-end to perform related calculation and data output of the virtual reality function, and the external PC-end virtual reality device using data output from the PC-end to realize the virtual reality effect.

The mobile virtual reality device, which supports providing a mobile terminal (for example, a smart phone) in various methods (for example, a head-mounted display with a special card slot) and wired or wireless connection with the mobile terminal, so that the mobile terminal performs related calculation of the virtual reality function and output data to the mobile virtual reality device, for example, watching a virtual reality video through APP of the mobile terminal.

The all-in-one virtual reality device, which is provided with a processor for related calculation of a virtual function, and thus has independent virtual reality input and output functions without connection with a PC-end or a mobile terminal, so that it has a high degree of freedom in use.

Of course, the forms of the extended reality device are not limited thereto, and may be provided to be further small-scale or large-scale as necessary.

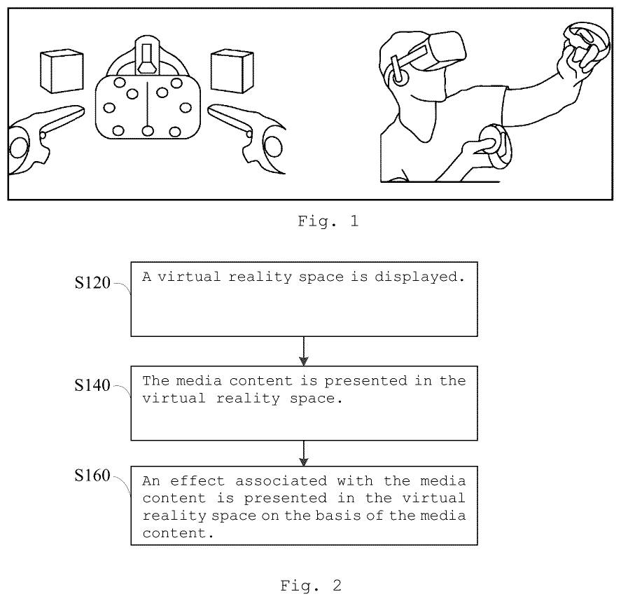

As shown in FIG. 1, the user may enter the virtual reality space through smart terminal devices such as head-mounted VR glasses, and control own avatar to carry out social interaction, entertainment, learning and remote office with avatars controlled by other users in the virtual reality space.

Wherein, the virtual reality space may be a simulated environment for the real world, a semi-simulated and semi-fictional virtual scene, or a pure-fictional virtual scene. The virtual scene may be any of a two-dimensional virtual scene, a 2.5-dimensional virtual scene or a three-dimensional virtual scene, and the dimensions of the virtual scene are not limited in the embodiment of the present application. For example, the virtual scene may comprise sky, land, ocean and the like, wherein the land may comprise environmental elements such as desert and city, and the user may control a virtual object to move in the virtual scene.

In an embodiment, in the virtual reality space, the user may realize a related interactive operation through the controller, which may be a handle, for example, the user may control a related operation by operating a button of the handle. Of course, in other embodiments, the target object in the virtual reality device may be controlled by a gesture, voice or multimodal control method instead of using a controller.

In some embodiments, the virtual reality space comprises a virtual live space or a virtual social space. In the virtual live space, the performer user may perform live with a virtual image or a real video, and the audience user may control an avatar to watch the live of the performer from a viewing angle such as a first-person perspective. In the virtual social space, the user may perform social and interactive activities through a virtual character. For example, the virtual reality space model of the performer is built by the virtual reality technology, and the virtual reality environment of the concert is generated by calculation based on this space model, in addition, technologies comprising auditory perception, tactile perception, motion perception, and even taste perception and smell perception may be provided to realize a fusion and interactive simulation of a three-dimensional dynamic scene and an entity behavior in the virtual environment, so that the user may be immersed in the simulated virtual reality environment; in this way, the performer may perform in the virtual reality environment, and when the user wears the virtual reality device, the user may enter the concert scene, and interact with the performer and enjoy the music feast through related perception technologies, so as to achieve the immersive experience effect of a real concert.

It is to be noted that, in the embodiment of the present disclosure, the image of the avatar may be created according to a real video of the user, or set in advance by the system, or created by user definition, and the present disclosure is not limited thereto here.

In step S140, the media content is presented in the virtual reality space.

In some embodiments, the media content comprises, but is not limited to, text, image, video, or audio.

In some embodiments, the media information stream may be obtained, and the media content may be presented in the virtual reality space based on the media information stream.

In some embodiments, the media information stream comprises a video stream and/or an audio stream, for example a live video stream and a live audio stream. Illustratively, the video stream may use an encoding format such as H.265, H.264 and MPEG-4. In one specific embodiment, the live audio or video stream sent by the server may be received.

In some embodiments, one or more display areas may be preset in the virtual reality space, so that the display area may be used to display the media content. Illustratively, the one or more display areas are equivalent to a virtual screen provided in the virtual reality space for playing a decoded audio or video.

In step S160, an effect associated with the media content is presented in the virtual reality space on the basis of the media content.

In some embodiments, the effect may comprise an effect or a group of effects.

In some embodiments, the presentation time of the effect may last for a preset duration, or continue until the effect is stopped or replaced with another effect.

In some embodiments, a resource repository for storing an effect file may be preset in the client, and after the effect indication information is determined, the client may retrieve a corresponding effect file from the resource repository for real-time rendering.

In some embodiments, the effect comprises at least one of the following: animation effects, changes to display elements in the virtual reality space, or changes to models of the virtual reality space. Illustratively, taking a live concert as an example, the display elements in the virtual reality space may comprise but are not limited to stage, scenery, lighting, props and other stage art designs.

In some embodiments, the presented effect corresponds to the style of the media content. Illustratively, taking the media content being a song as an example for explanation, if the style of the song is passionate and unconstrained, a florid and dynamic effect may be selected; and if the style of the song is quiet and soothing, an elegant and peaceful effect may be selected.

According to one or more embodiments of the present disclosure, the effect associated with the media content is presented in the virtual reality space on the basis of the media content, so that the corresponding effect can be presented while the media content is displayed in the virtual reality space, thereby enabling users to obtain richer interactive experience in the virtual reality space.

In some embodiments, there is a preset association relationship between the effect and the media content indicated by the media content information.

In some embodiments, the effect may comprise one or more preset effects presented at one or more preset time points.

In one specific implementation, the duration of the effect corresponds to the duration of its corresponding media content.

In one specific implementation, if the media content is a song, the effect comprises animation images corresponding to the target lyrics or target melodies in the song.

In some embodiments, corresponding effect scripts may be set in advance for different media contents (for example, a song), and the effect scripts may be used to set a certain effect to appear in some minutes and some seconds of the media content, so that the effect corresponds to media content elements (for example, plots, lyrics, melodies, or emotional flows). For example, if the lyrics “Kongming Lantern” and “peach flower” and the melody climax of the song appear in 0 minute, 10 seconds, 20 seconds and 30 seconds of the song A respectively, animation image effects such as “Kongming Lantern”, “peach flower”, Kongming Lantern floating and peach flower blossom may be set in 0 minute, 10 seconds, 20 seconds and 30 seconds correspondingly.

In some embodiments, the step S160 further comprises: obtaining the effect information associated with the target media content corresponding to a user operation in response to a preset operation on the presented media content by the user, and presenting the effect in the virtual reality space on the basis of the effect information.

In some embodiments, the preset operation comprises, but is not limited to, a motion control operation, a gesture control operation, an eye ball jitter operation, a touch control operation, a voice control instruction, or a preset operation on an external control device.

Illustratively, a user may manipulate an avatar to touch the text information presented in the media content so as to trigger the effect information corresponding to the text information, and present the effect in the virtual reality space on the basis of the effect information. For example, when the media content displays the text information “Kongming Lantern”, the corresponding effect resource file of “Kongming Lantern” may be obtained based on a preset operation for the text information, and the effect of “Kongming Lantern” may be presented in the virtual reality space on the basis of the effect resource file.

In one specific embodiment, different effect information may be preset for different media content elements and stored in the client, so that when the media content elements are triggered by the user, the client may retrieve the corresponding effect information to present the corresponding effect.

In some embodiments, the step S160 further comprises that:

In step S161, an effect associated with the media content is presented in the virtual reality space on the basis of a presenting timeline of the media content.

In some embodiments, for a plurality of media content presented at different time points sequentially, a plurality of corresponding effects may be set sequentially according to the timeline presented by the plurality of media content; alternatively, for a plurality of media content elements of the same media content presented at different time points, a plurality of corresponding effects may be set sequentially according to the timelines presented by the plurality of media content units.

In some embodiments of the present disclosure, the media content elements are units that make up the media content. For example, if the media content comprises a song, the media content elements may comprise some lyrics and melodies of the song; and if the media content is a video, the media content elements may comprise some subtitles, plots and the like of the video.

In some embodiments, the step S161 further comprises that:

In step A1, the effect indication information is determined on the basis of the obtained media information flow, wherein the effect indication information is used to indicate a first effect to be presented together with the media content.

In step A2, the first effect is presented in the virtual reality space on the basis of the effect indication information.

In some embodiments, the first effect comprises an effect of the presented scene of the media content set in the virtual reality space; alternatively, the first effect comprises an animation effect corresponding to a specific element associated with the media content.

In some embodiments, the effect indication information may be determined on the basis of the currently obtained media information stream. Illustratively, the effect indication information may use the form of supplementary enhancement information (SEI). The supplementary enhancement information is the additional information that might be comprised in the video stream, for example, user-defined information, to increase the availability of the video so that the video is more widely applied. The supplementary enhancement information may be packaged and sent together with the video frame, so as to achieve the effect of synchronously sending and parsing the supplementary enhancement information and the video frame. In this way, when the client decodes the media information stream, the effect indication information may be determined through the supplementary enhancement information in the media information stream.

According to one or more embodiments of the present disclosure, by determining the effect indication information on the basis of the effect indication information carried by the media information stream, the effect corresponding to the media content may be determined and presented in real time when the media content is displayed, especially during a live video.

In some embodiments, the step A1 further comprises that:

In step all, the effect indication information is determined on the basis of the supplementary enhancement information in the currently obtained media information stream.

Next, explanation will be made with a live video as an example. When a performer prepares or begins to perform live performance of a program A, the performer may package the supplementary enhancement information (comprising a serial number of the effect a, for example) corresponding to the effect a into the media information stream together with the current video frame in response to a preset user instruction, and send the same to the client of the audience via the server; the client of the audience may obtain the effect indication information on the basis of the supplementary enhancement information whilst decoding the current video frame, so that the client of the audience may start to present the effect a correspondingly. Similarly, when the performer prepares or begins to perform the program B after performing the program A, a relevant person may trigger an instruction of using the effect b corresponding to the program B again on the performer end, so as to finally allow that the client of the audience is changed from presenting the effect a to presenting the effect b. In one specific implementation, the current video frame is an initial frame of the program A.

In some embodiments, the method 100 further comprises steps B1 to B3:

In step B1, the media content information is determined, wherein the media content information is used to indicate media content that is currently being presented or to be presented.

Illustratively, the media content information may comprise the name of a program that the performer is currently performing or will begin to perform, for example, the name of a song.

In some embodiments, the media content information may be determined on the basis of the currently obtained media information stream. Illustratively, the media content information may use the form of supplementary enhancement information. The supplementary enhancement information is the additional information that might be comprised in the video stream, for example, user-defined information, to increase the availability of the video so that the video is more widely applied. The supplementary enhancement information may be packaged and sent together with the video frame, so as to achieve the effect of synchronously sending and parsing the supplementary enhancement information and the video frame. In this way, when the client decodes the media information stream, the media content information may be determined through the supplementary enhancement information in the media information stream.

In step B2, a second effect solution is determined on the basis of the media content information.

In some embodiments, there is a preset association relationship between the second effect solution and the media content indicated by the media content information.

In some embodiments, the second effect solution may provide one or more preset effects presented at one or more preset time points.

In one specific implementation, the duration of the second effect solution corresponds to the duration of its corresponding media content.

In one specific implementation, if the media content is a song, the second effect solution comprises animation images corresponding to the target lyrics or target melodies in the song.

In some embodiments, corresponding effect scripts may be set in advance for different media contents (for example, a song), and the effect scripts may be used to set a certain effect to appear in some minutes and some seconds of the media content, so that the effect corresponds to specific media content elements (for example, plots, lyrics, melodies, or emotional flows). For example, if the lyrics “Kongming Lantern” and “peach flower” and the melody climax of the song appear in 0 minute, 10 seconds, 20 seconds and 30 seconds of the song A respectively, animation image effects such as “Kongming Lantern”, “peach flower”, Kongming Lantern floating and peach flower blossom may be set in 0 minute, 10 seconds, 20 seconds and 30 seconds correspondingly.

In B3, a second effect is presented in the virtual reality space on the basis of the second effect solution.

In some embodiments, different second effect solutions may be set in advance for different media contents, and a corresponding effect file may be stored in the resource repository of the client; After a specific effect solution is determined, the client may retrieve a corresponding effect file for real-time rendering.

Next, explanation will be made with a live video as an example. Illustratively, a corresponding second effect solution a-c may be preset for a program A-C to be performed by the performer. If the performer is ready to begin performing the program C at present, the performer may package the supplementary enhancement information (comprising a serial number of a program name corresponding to the program C, for example) corresponding to the program C into the media information stream together with the current video frame in response to a preset user instruction, and send the same to the client of the audience via the server; The client of the audience may determine the media content information on the basis of the supplementary enhancement information whilst decoding the current video frame, so that the client of the audience may start to present the second effect solution c correspondingly. In one specific implementation, the current video frame is an initial frame of the program.

In some embodiments, the supplementary enhancement information corresponds to an initial frame of the performance content or the performance program. Illustratively, the corresponding supplementary enhancement information a-c may be set for the initial frame of the performance program A-C.

In some embodiments, the first effect comprises an effect of a presented scene of the media content set in the virtual reality space; and/or the second effect comprises an animation image corresponding to a media content element in the presented media content.

In this embodiment, the first effect is set for a presented scene of the media content and the second effect is set for a media content element in the presented media content, so that the interactive experience of users in the virtual reality space may be enriched.

In some embodiments, the presented scene of the media content may comprise stage art designs such as stage, scenery, lighting, or props. For example, the first effect may be a stage scenery effect or a stage lighting effect.

In some embodiments, the media content elements may be the elements of the media content such as plots, lyrics, texts, melodies or emotional flows of the media content. In one specific implementation, if the media content elements (for example, lyrics, plots and lines) are present with objects such as “Kongming Lantern”, “Paper Plane” and “Petal”, the second effect may comprise animation images corresponding to the objects such as “Kongming Lantern”, “Paper Plane” and “Petal”.

In some embodiments, the method 100 further comprises that:

In step C1, the secondary effect corresponding to the target effect is presented in response to a preset operation for the target effect presented in the virtual reality space.

For example, a user may trigger a target effect through a preset operation for the target effect presented in the virtual reality space, for example, a motion control operation, a gesture control operation, an eye ball jitter operation, a touch control operation, a voice control instruction, or a preset operation on an external control device, so as to present a secondary effect corresponding to the target effect.

In some embodiments, the target effect comprises a second effect.

An exemplary explanation will be given below. When the second effect corresponding to the media content element is presented in the virtual reality space, the user may control own avatar to touch one or more preset second effects; for example, if the user controls the avatar to touch the animation image of “Kongming Lantern”, the effect of “Kongming Lantern floating” will be presented; if the user controls the avatar to touch the animation image of “paper plane”, the effect of “paper plane turning into words” will be presented; if the user controls the avatar to touch the animation image of “petals”, the effect of “petal dancing” will be presented.

In some embodiments, the virtual reality space comprises a virtual live space or a virtual social space. In the virtual live space, the performer user may perform live with a virtual image or a real video, and the audience user may control an avatar to watch the live of the performer from a viewing angle such as a first-person perspective.

In some embodiments, the virtual live space comprises a performance area and a viewing area, wherein the performance area is used to present the performance content (for example, a virtual image or real image of the performer) or other media content of the performer and a corresponding stage scenery, and the viewing area is used to present an avatar controlled by the audience user.

Referring to FIG. 3, the virtual reality space is presented in a first-person perspective or other perspective screens 10 of an avatar controlled by a user, and the virtual reality space has a preset video display area 20, as well as a stage 30, a scenery 40 and a viewing area 50 adapted to the video display area. The video display area 20 is used to present the live video stream of the performer, and the audience user may control the avatar 60 to enter the viewing area 50 so as to watch a video displayed in the video display area 20 from a first-person perspective or other perspectives.

According to one or more embodiments of the present disclosure, when the video display area 20 currently displays the first media content A, the stage 30 and the scenery 40 may display the first effect corresponding to the first media content A; when the first media content A presents the first media content element a, a second effect corresponding to the first media content element a may be presented in the virtual reality space, for example, in the viewing area 50 or other areas; when the user controls the avatar to touch the second effect, it is possible to further trigger the secondary effect corresponding to the second effect.

Similarly, if the content displayed in the video display area 20 is shifted from the first media content A to the second media content B, the stage 30 and the scenery 40 may display the first effect corresponding to the second media content B; when the second media content B presents the second media content element b, the second effect corresponding to the second media content element b may be presented in the virtual reality space; when the user controls the avatar to touch the second effect, it is possible to further trigger the secondary effect corresponding to the second effect.

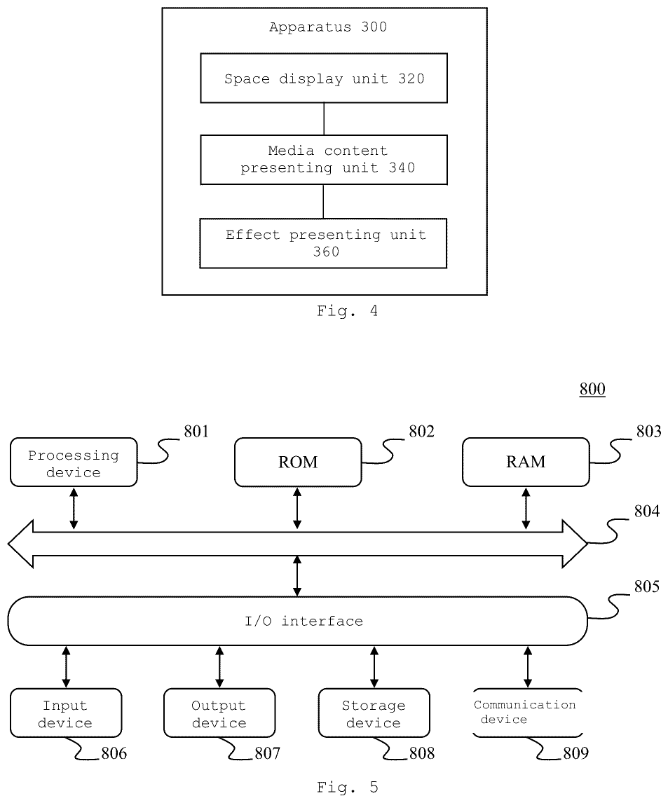

Accordingly, as shown in FIG. 4, according to an embodiment of the present disclosure, an effect display apparatus 300 is provided, the apparatus comprising:
a space display unit 320 configured to display a virtual reality space;
a media content presenting unit 340 configured to present media content in the virtual reality space; and
an effect presenting unit 360 configured to present an effect associated with the media content in the virtual reality space on the basis of the media content.

According to one or more embodiments of the present disclosure, the effect presenting unit 360 is configured to determine the effect indication information on the basis of the obtained media information stream, wherein the effect indication information is used to indicate the first effect to be presented together with the media content; and configured to present the first effect in the virtual reality space on the basis of the effect indication information.

According to one or more embodiments of the present disclosure, the effect presenting unit 360 is configured to present an effect associated with the media content in the virtual reality space on the basis of a presenting timeline of the media content.

According to one or more embodiments of the present disclosure, the effect presenting unit 360 is configured to obtain the effect information associated with the target media content corresponding to an operation by the user in response to a preset operation on the presented media content by the user, and present the effect in the virtual reality space on the basis of the effect information.

The effect display apparatus provided according to one or more embodiments of the present disclosure further comprises: a secondary effect unit configured to present a secondary effect corresponding to the target effect in response to a preset operation for the target effect presented in the virtual reality space.

The effect display apparatus provided according to one or more embodiments of the present disclosure further comprises: a content information determining unit configured to determine the media content information, wherein the media content information is used to indicate media content that is currently being presented or to be presented;
a second effect determining unit configured to determine a second effect solution on the basis of the media content information; and a second effect presenting unit configured to present a second effect in the virtual reality space on the basis of the second effect solution.

According to one or more embodiments of the present disclosure, the determining the effect indication information on the basis of the obtained media information stream comprises determining the effect indication information on the basis of the supplementary enhancement information in the currently obtained media information stream.

As for the device embodiments, since they substantially correspond to the method embodiments, for relevant parts, reference may be made to some descriptions of the method embodiments. The device embodiments described above are only schematic, wherein the modules described as separate modules may or may not be divided. Some or all of the modules may be selected to achieve the object of the solution in the present embodiment according to actual needs. Those of ordinary skill in the art may understand and implement in the case where no inventive effort is involved.

Correspondingly, according to one or more embodiments of the present disclosure, an electronic device is provided, wherein the electronic device comprises:
at least one memory and at least one processor;
wherein the memory is configured to store program codes, and the processor is configured to call the program codes stored in the memory to cause the electronic device to perform the effect display method provided according to one or more embodiments of the present disclosure.

Correspondingly, according to one or more embodiments of the present disclosure, a non-transient computer storage medium is provided, the non-transient computer storage medium having program codes stored therein that may be executed by a computer device to cause the computer device to perform the effect display method provided according to one or more embodiments of the present disclosure.

Next, referring to FIG. 5, it shows a structural schematic view of an electronic device 800 (for example, a terminal device or server) suitable for implementing the embodiment of the present disclosure. The terminal device in an embodiment of the present disclosure may comprise, but is not limited to, mobile terminals such as mobile phones, notebook computers, digital broadcast receivers, PDAS (personal digital assistants), PADS (pad computers), PMP (Portable Multimedia Player), in-vehicle terminals (for example, in-vehicle navigation terminals) and the like; and fixed terminals such as digital TVs, desktop computers and the like. The electronic device shown in FIG. 5 is only an example, and shall not limit the functions and application range of the embodiments of the present disclosure.

As shown in FIG. 5, the electronic device 800 may comprise a processing device (for example, a central processing unit, a graphic processor, and the like) 801, which may perform various suitable actions and processing according to a program stored in a Read-only Memory (ROM) 802 or a program loaded from a storage device 808 into a Random Access Memory (RAM) 803. In the RAM 803, various programs and data required for the operation of the electronic device 800 are also stored. The processing device 801, the ROM 802 and the RAM 803 are connected to each other through a bus 804. The input/output (I/O) interface 805 is also connected to the bus 804.

Generally, the following devices may be connected to the I/O interface 805: an input device 806 comprising, for example, a touch screen, a touch pad, a keyboard, a mouse, a camera, a microphone, an accelerometer, a gyroscope, and the like; an output device 807 comprising, for example, a Liquid Crystal Display (LCD), a speaker, a vibrator, and the like; a storage device 808 comprising, for example, a magnetic tape, a hard disk, and the like; and a communication device 809. The communication device 809 may allow the electronic device 800 to be in wireless or wired communication with other devices to exchange data. Although FIG. 5 shows the electronic device 800 with various devices, it should be understood that there is no requirement to implement or have all the devices shown. It is possible to alternatively implement or possess more or less devices.

In particular, according to an embodiment of the present disclosure, the process described above with reference to the flowchart may be implemented as a computer software program. For example, an embodiment of the present disclosure comprises a computer program product, which comprises a computer program carried on a computer-readable medium, wherein the computer program contains program codes for performing the method shown in the flow chart. In such embodiment, the computer program may be downloaded and installed the from network through the communication device 809, installed from the storage device 808, or installed from the ROM 802. When the computer program is executed by the processing device 801, the above-described functions defined in the method of the embodiment of the present disclosure are performed.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may comprise, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, device, or apparatus, or used in combination therewith. In the present disclosure, the computer-readable signal medium may comprise a data signal propagated in a baseband or as a part of a carrier wave, wherein a computer-readable program code is carried. Such propagated data signal may take many forms, comprising but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program for use by an instruction execution system, device, or apparatus in combination with therewith. The program code contained on the computer-readable medium may be transmitted by any suitable medium, comprising but not limited to: a wire, an optical cable, radio frequency (RF), and the like, or any suitable combination thereof.

In some embodiments, the client and the server may communicate using any currently known or future developed network protocol such as HTTP (HyperText Transfer Protocol), and may be interconnected with digital data communication (for example, communication network) in any form or medium. Examples of communication networks comprise a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be comprised in the above-described electronic device; or may also exist alone without being assembled into the electronic device.

The above-described computer-readable medium carries one or more programs that, when executed by the electronic device, cause the electronic device to perform the above-described method of the present disclosure.

The computer program code for performing the operations of the present disclosure may be written in one or more programming languages or a combination thereof, wherein the above-described programming languages comprise object-oriented programming languages, such as Java, Smalltalk, and C++, and also comprise conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the case of a remote computer, the remote computer may be connected to the user's computer through any kind of network (comprising a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession may actually be executed substantially in parallel, and may sometimes also be executed in a reverse order, depending on the functions involved. It should also be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The units involved in the described embodiments of the present disclosure may be implemented in software or hardware. Wherein, the names of the units do not constitute a limitation on the units themselves under certain circumstances.

The functions described hereinabove may be performed at least in part by one or more hardware logic components. For example, without limitation, the hardware logic components of a demonstrative type that may be used comprise: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, a machine-readable medium may be a tangible medium, which may contain or store a program for use by the instruction execution system, device, or apparatus or use in combination with the instruction execution system, device, or apparatus. The machine-readable medium may be a machine-readable signal medium or a machine-readable storage medium. The machine-readable medium may comprise, but is not limited to, an electronic, magnetic, optical, electromagnetic, infrared, or semiconductor system, device or apparatus, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, an effect display method is provided, the method comprises:
displaying a virtual reality space;
presenting media content in the virtual reality space; and
presenting an effect associated with the media content in the virtual reality space on the basis of the media content.

According to one or more embodiments of the present disclosure, the presenting an effect associated with the media content in the virtual reality space on the basis of the media content comprises:
presenting an effect associated with the media content in the virtual reality space on the basis of a presenting timeline of the media content.

According to one or more embodiments of the present disclosure, the presenting an effect associated with the media content in the virtual reality space on the basis of a presenting timeline of the media content comprises:
determining the effect indication information on the basis of the obtained media information stream, wherein the effect indication information is used to indicate a first effect to be presented together with the media content; and
presenting the first effect in the virtual reality space on the basis of the effect indication information.

According to one or more embodiments of the present disclosure, the presenting an effect associated with the media content in the virtual reality space on the basis of the media content comprises:
obtaining the effect information associated with the target media content corresponding to an operation by the user in response to a preset operation on the presented media content by the user, and presenting the effect in the virtual reality space on the basis of the effect information.

The effect display method provided according to one or more embodiments of the present disclosure further comprises:
presenting a secondary effect corresponding to the target effect in response to a preset operation for a target effect presented in the virtual reality space.

The effect display method provided according to one or more embodiments of the present disclosure further comprises:
determining the media content information, wherein the media content information is used to indicate media content that is currently being presented or to be presented;
determining a second effect solution on the basis of the media content information; and
presenting a second effect in the virtual reality space on the basis of the second effect solution.

According to one or more embodiments of the present disclosure, there is a preset association relationship between the second effect solution and the media content indicated by the media content information.

According to one or more embodiments of the present disclosure, the effect comprises at least one of the following: animation effects, changes to display elements in virtual reality space, or changes to models of virtual reality space.

According to one or more embodiments of the present disclosure, the first effect comprises an effect of a presented scene of the media content set in the virtual reality space; or the first effect comprises an animation effect corresponding to a specific element associated with the media content.

According to one or more embodiments of the present disclosure, the presented scene of the media content comprises one or more of the following: stage, scenery, lighting or props.

According to one or more embodiments of the present disclosure, the second effect comprises an animation image corresponding to a media content element in the presented media content.

According to one or more embodiments of the present disclosure, if the media content is a song, the second effect comprises an animation image corresponding to a target lyric or a target melody in the song.

According to one or more embodiments of the present disclosure, the target effect comprises a second effect.

According to one or more embodiments of the present disclosure, the determining the effect indication information on the basis of the obtained media information stream comprises: determining the effect indication information on the basis of the supplementary enhancement information in the currently obtained media information stream.

According to one or more embodiments of the present disclosure, an effect display apparatus is provided, the apparatus comprises:
a space display unit for displaying a virtual reality space;
a media content presenting unit for presenting media content in the virtual reality space; and
an effect presenting unit for presenting an effect associated with the media content in the virtual reality space on the basis of the media content.

According to one or more embodiments of the present disclosure, an electronic device is provided, the electronic device comprises: at least one memory and at least one processor; wherein, the memory is used for storing program codes, and the processor is used for calling the program codes stored in the memory to cause the electronic device to perform the effect display method provided according to one or more embodiments of the present disclosure.

According to one or more embodiments of the present disclosure, a non-transient computer storage medium is provided, the non-transient computer storage medium has program codes stored therein that, when executed by a computer device, cause the computer device to perform the effect display method provided according to one or more embodiments of the present disclosure.

The above description is only an explanation of preferred embodiments of the present disclosure and the applied technical principles. Those skilled in the art should understand that the scope of disclosure involved in the present disclosure is not limited thereto to the technical solutions formed by the specific combination of the above technical features, and at the same time should also cover other technical solutions formed by arbitrarily combining the above-described technical features or equivalent features without departing from the above disclosed concept. For example, a technical solution formed by the above-described features and the technical features disclosed in the present disclosure (but not limited thereto) having similar functions replaced with each other.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although the present subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

1. An effect display method, characterized in that it comprises:
displaying a virtual reality space;
presenting media content in the virtual reality space; and
presenting an effect associated with the media content in the virtual reality space on the basis of the media content.

2. The method according to claim 1, characterized in that the presenting an effect associated with the media content in the virtual reality space on the basis of the media content comprises:
presenting an effect associated with the media content in the virtual reality space on the basis of a presenting timeline of the media content.

3. The method according to claim 2, characterized in that the presenting an effect associated with the media content in the virtual reality space on the basis of a presenting timeline of the media content comprises:
determining effect indication information on the basis of an obtained media information stream, wherein the effect indication information is used to indicate a first effect to be presented together with the media content; and
presenting the first effect in the virtual reality space on the basis of the effect indication information.

4. The method according to claim 1, characterized in that the presenting an effect associated with the media content in the virtual reality space on the basis of the media content comprises:
obtaining effect information associated with target media content corresponding to an operation by the user in response to a preset operation on presented media content by the user, and presenting the effect in the virtual reality space on the basis of the effect information.

5. The method according to claim 1, characterized in that it further comprises:
presenting, in response to a preset operation for a target effect presented in the virtual reality space, a secondary effect corresponding to the target effect.

6. The method according to claim 1, characterized in that it further comprises:
determining media content information, wherein the media content information is used to indicate media content that is currently being presented or to be presented;
determining a second effect solution on the basis of the media content information; and
presenting a second effect in the virtual reality space on the basis of the second effect solution.

7. The method according to claim 6, characterized in that,
there is a preset association relationship between the second effect solution and the media content indicated by the media content information.

8. The method according to claim 1, characterized in that, the effect comprises at least one of the following:
an animation effect, a change to a display element in the virtual reality space, or a change to a model of virtual reality space.

9. The method according to claim 3, characterized in that,
the first effect comprises an effect of a presented scene of the media content set in the virtual reality space; or,
the first effect comprises an animation effect corresponding to a specific element associated with the media content.

10. The method according to claim 9, characterized in that,
the presented scene of the media content comprises one or more of the following: stage, scenery, lighting or props.

11. The method according to claim 6, characterized in that,
the second effect comprises an animation image corresponding to a media content element in the presented media content.

12. The method according to claim 11, characterized in that,
if the media content is a song, the second effect comprises an animation image corresponding to a target lyric or target melody in the song.

13. The method according to claim 5, characterized in that,
the target effect comprises a second effect.

14. The method according to claim 3, characterized in that, the determining effect indication information on the basis of the obtained media information flow comprises:
determining the effect indication information on the basis of supplementary enhancement information in a currently obtained media information stream.

15. (canceled)

16. An electronic device, characterized in that it comprises:
at least one memory and at least one processor;
wherein the memory is configured for storing program codes, and the processor is configured for calling the program codes stored in the memory to cause the electronic device to perform an effect display method comprising:
displaying a virtual reality space;
presenting media content in the virtual reality space; and
presenting an effect associated with the media content in the virtual reality space on the basis of the media content.

17. A non-transient computer storage medium, characterized in that,
the non-transient computer storage medium has program codes stored thereon that, when executed by a computer device, cause the computer device to perform an effect display method comprising:
displaying a virtual reality space;
presenting media content in the virtual reality space; and
presenting an effect associated with the media content in the virtual reality space on the basis of the media content.

18. The electronic device according to claim 16, characterized in that the presenting an effect associated with the media content in the virtual reality space on the basis of the media content comprises:
presenting an effect associated with the media content in the virtual reality space on the basis of a presenting timeline of the media content.

19. The electronic device according to claim 18, characterized in that the presenting an effect associated with the media content in the virtual reality space on the basis of a presenting timeline of the media content comprises:
determining effect indication information on the basis of an obtained media information stream, wherein the effect indication information is used to indicate a first effect to be presented together with the media content; and
presenting the first effect in the virtual reality space on the basis of the effect indication information.

20. The non-transient computer storage medium according to claim 17, characterized in that the presenting an effect associated with the media content in the virtual reality space on the basis of the media content comprises:
presenting an effect associated with the media content in the virtual reality space on the basis of a presenting timeline of the media content.

21. The non-transient computer storage medium according to claim 20, characterized in that the presenting an effect associated with the media content in the virtual reality space on the basis of a presenting timeline of the media content comprises:
determining effect indication information on the basis of an obtained media information stream, wherein the effect indication information is used to indicate a first effect to be presented together with the media content; and
presenting the first effect in the virtual reality space on the basis of the effect indication information.
